(19) United States
(12) Patent Application Publication
(10) Pub. No.: US 2007/0089072 A1
(43) Pub. Date: Apr. 19, 2007

(54) SIGNAL TRANSMISSION STRUCTURE

(75) Inventors: YU-HSU LIN, San Jose, CA (US); SHANG-TSANG YEH, Tu-Cheng,Taipei Hsien (TW); CHUAN-BING LI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,537

(22) Filed: Aug. 18, 2006

(30) Foreign Application Priority Data
Oct. 17, 2005 (CN) 200510100548.4

(51) Int. Cl. G06F 17/50

(52) U.S. Cl. 716/2; 716/5

(57) ABSTRACT

A signal transmission structure includes an aggressor line and a victim line parallel with the aggressor line, and a number of delay portions formed in the victim line. Noise due to crosstalk passing through the delay portion is delayed an amount of time equal to or greater than a rise time of a signal transmitted in the aggressor line. It is of advantage that introducing the delay portions into a victim line of parallel transmission lines can reduce crosstalk caused by mutual inductance and mutual capacitance between the parallel transmission lines.

### 1. FIELD OF THE INVENTION

The present invention relates to techniques of transmitting electrical signals, and particularly to a signal transmission structure that can reduce crosstalk between parallel transmission lines.

### 2. DESCRIPTION OF RELATED ART

Mutual capacitance is the coupling of two electric fields, where electrical current proportional to the rate of change of voltage in a driver flows into a target line. The shorter the distance between two electrically conductive objects, the greater is their mutual capacitance. Similarly, if two conductors are brought into close proximity with each other so that the magnetic field of one conductor interacts with the magnetic field of the other conductor, a voltage is generated in the second conductor as a result. This is called mutual inductance.

Crosstalk is the electrical “noise” caused by mutual inductance and mutual capacitance as between signal conductors, due to the close proximity of the signal conductors to each other. Crosstalk can cause digital system failure due to false signals appearing on a receiver.

What is needed, therefore, is a signal transmission structure that can reduce crosstalk between parallel transmission lines.

### SUMMARY OF INVENTION

An exemplary transmission structure includes an aggressor line and a victim line parallel with the aggressor line, a number of delay portions are connected in the victim line. Noise due to crosstalk passing through the delay portion is delayed an amount of time equal to or greater than a rise time of a signal transmitted in the aggressor line.

It is of advantage that introducing at least one delay portion into a victim line of parallel transmission lines reduces crosstalk caused by mutual inductance and mutual capacitance between the parallel transmission lines.

Other advantages and novel features will become more apparent from the following detailed description of preferred embodiments when taken in conjunction with the accompanying drawings, in which:

### BRIEF DESCRIPTION OF DRAWINGS

FIG. 1 is diagram of a signal transmission structure in accordance with a first preferred embodiment of the present invention;

FIG. 2 is a graph showing signal waveforms obtained using the structure of FIG. 1 and a conventional structure; and

FIG. 3 is a diagram of a signal transmission structure in accordance with a second preferred embodiment of the present invention.

### DETAILED DESCRIPTION

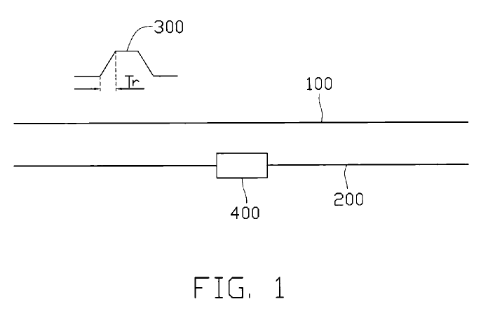

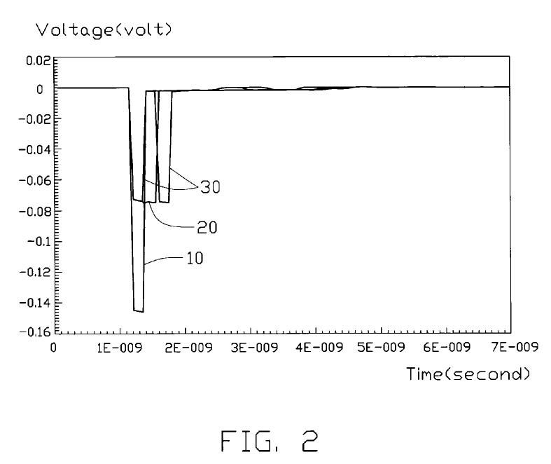

Referring to FIG. 1, a signal transmission structure of a first embodiment of the present invention includes two parallel transmission lines, one is an aggressor line 100, the other is a victim line 200. A delay portion 400 is formed in a center of the victim line 200. The delay portion 400 can be a signal line with a serpentine shape or a resistor-capacitor (RC) delay circuit. Tr denotes a rise time of a signal 300 transmitted through the aggressor line 100. In this embodiment, the rise time is 200 ps (picoseconds). FIG. 2 is a graph showing signal waveforms obtained in the victim line 200 using the structure of FIG. 1 and a conventional transmission structure without a delay portion, curve 10 denotes the waveform of the crosstalk obtained using the conventional transmission structure. Noise due to the crosstalk passing through the victim line 200 is delayed in the delay portion 400 an amount of time equal to the rise time Tr, curve 20 denotes the waveform of the crosstalk obtained using the transmission structure of FIG. 1. As shown in FIG. 2, the amplitude of the curve 20 is half of the amplitude of the curve 10. Curve 30 denotes the waveform obtained using the transmission structure of FIG. 1 if noise due to the crosstalk passing through the victim line 200 is delayed in the delay portion 400 twice the amount of time as the rise time Tr, just 400 ps. It can be seen that the amplitude of the curve 30 is also half of the amplitude of the curve 10.

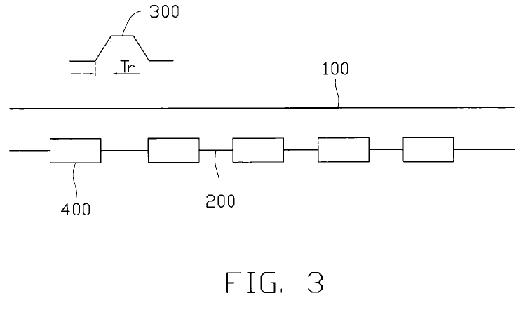

Referring to FIG. 3, a signal transmission structure of a second embodiment of the present invention includes two parallel transmission lines, one is an aggressor line 100, the other is a victim line 200. Five delay portions 400 are formed in the victim line 200. Each delay portion 400 can be a signal line with a serpentine shape or a delay circuit, which is composed of resistors and capacitors. Tr denotes a rise time of a signal 300 transmitted through the aggressor line 100. In this embodiment, the rise time Tr is 200 ps, and noise due to the crosstalk passing through the victim line 200 is delayed in the delay portions 400 an amount of time equal to or greater than the rise time Tr. Using the transmission structure of FIG. 3, the crosstalk will also be reduced to ⅕ that when there are no delay portions in the victim line.

In practice, it is preferred that the number of the delay portions be from 1 to 5.

It is to be understood, however, that even though numerous characteristics and advantages of the present embodiment has been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A signal transmission structure comprising an aggressor line, a victim line parallel with the aggressor line, and at least one delay portion formed in the victim line, wherein noise due to crosstalk passing through the delay portion is delayed an amount of time equal to or greater than a rise time of a signal transmitted in the aggressor line.

2. The signal transmission structure as claimed in claim 1, wherein said delay portion is a signal line with a serpentine shape.

3. The signal transmission structure as claimed in claim 2, wherein a length of the signal line of said delay portion equals to a length that a signal is transmitted through the aggressor line during the rise time.

4. The signal transmission structure as claimed in claim 1, wherein said delay portion is a resistor-capacitor (RC) delay circuit.

5. A method for reducing crosstalk between parallel transmission lines comprising an aggressor line and a victim line, the method comprising the step of forming at least one delay portion in the victim line, wherein noise due to crosstalk passing through the delay portion is delayed an amount of time equal to or greater than a rise time of a signal transmitted in the aggressor line.

6. The method as claimed in claim 5, wherein said delay portion is a signal line with a serpentine shape.

7. The method as claimed in claim 5, wherein said delay portion is a resistor-capacitor (RC) delay circuit.

8. A signal transmission structure comprising an aggressor line, a victim line parallel with the aggressor line, the victim line being separated into X sections with same length by Y delay portions connected between the sections, wherein noise due to crosstalk passing through the at least one delay portion is delayed an amount of time equal to or greater than a rise time of a signal transmitted in the aggressor line, a maximum value of the crosstalk is reduced to 1/X of that when the victim line is not separated, Y is equal to X minus 1, X is natural number greater than 1.

9. The signal transmission structure as claimed in claim 8, wherein said delay portion is a signal line with a serpentine shape.

10. The signal transmission structure as claimed in claim 8, wherein said delay portion is a resistor-capacitor (RC) delay circuit.

11. The signal transmission structure as claimed in claim 8, wherein the victim line is separated into two sections by one delay portion connected between the two sections, a maximum value of the crosstalk is reduced to a half of that when the victim line is not separated.

12. The signal transmission structure as claimed in claim 8, wherein the victim line is separated into six sections by five delay portions each connected between corresponding adjacent two sections, a maximum value of the crosstalk is reduced to ⅕ that when the victim line is not separated.
